(19) United States
(12) Patent Application Publication
(10) Pub. No.: US 2025/0133078 A1
(43) Pub. Date: Apr. 24, 2025

(54) METHOD FOR AUTHENTICATING, AUTHORIZING, AND AUDITING LONG-RUNNING AND SCHEDULED OPERATIONS

(71) Applicant: VMware LLC, Palo Alto, CA (US)

(72) Inventors: NARASIMHA GOPAL GORTHI, Bangalore (IN); NARASIMHA MURTHI, Bangalore (IN); NIDHIN URMESE, Bangalore (IN)

(21) Appl. No.: 18/607,311

(22) Filed: Mar. 15, 2024

(30) Foreign Application Priority Data
Oct. 19, 2023 (IN) 202341071427

(51) Int. Cl. H04L 9/40

(52) U.S. Cl. CPC H04L 63/0876

(57) ABSTRACT

A method of issuing one or more commands for a management appliance of a software-defined data center (SDDC) to perform an operation, includes the steps of: retrieving the operation to be performed by the management appliance; transmitting a request to the management appliance for a first token, wherein the first token is associated with permissions for issuing commands to the management appliance, and wherein the request for the first token includes a second token that is associated with the initiator of the operation and that has a longer time-to-live period than the first token has; and upon receiving the first token from the management appliance, transmitting the first token and a command to the management appliance, wherein the command is for the management appliance to execute at least one task of the operation.

### CROSS-REFERENCE

This application is based upon and claims the benefit of priority from Indian Patent Application number 202341071427 filed on Oct. 19, 2023, the entire contents of which are incorporated herein by reference.

### BACKGROUND

In a software-defined data center (SDDC), virtual infrastructure (VI), which includes virtual machines (VMs) and virtualized storage and networking resources, is provisioned from hardware infrastructure. The hardware infrastructure includes a plurality of host computers, referred to herein simply as “hosts,” and includes storage and networking devices. The provisioning of the VI is carried out by SDDC management software that is deployed on management appliances such as a VMware vCenter Server® appliance and a VMware NSX® appliance, available from VMware, Inc. The SDDC management software manages the VI by communicating with virtualization software (e.g., hypervisors) installed in the hosts.

It has become common to deploy multiple SDDCs across multiple clusters of hosts. Each cluster is a group of hosts that are managed together by SDDC management software to provide cluster-level functions. For example, the functions include load balancing across the cluster through VM migration between the hosts, distributed power management, dynamic VM placement according to affinity and anti-affinity rules, and high availability (HA). The SDDC management software also manages shared storage devices from which storage resources for the clusters are provisioned. The SDDC management software also manages software-defined networks (SDNs) through which the VMs communicate.

Today, many organizations have SDDCs deployed across different geographical regions and even in a hybrid manner. A hybrid deployment includes applications running in a combination of different environments, e.g., on-premise, in a private cloud, in a public cloud, and as a service. SDDCs that are deployed on-premise are provisioned in a particular organization's own information technology (IT) environment. SDDCs that are deployed in a private cloud are provisioned in a private data center controlled by the organization. SDDCs that are deployed in a public cloud are provisioned in a public data center at which SDDCs of other organizations are also provisioned. SDDCs that are deployed as a service are provided to the organization on a subscription basis such that management operations such as configuring, upgrading, and patching are performed for the organization according to a service-level agreement (SLA).

With increasing numbers of SDDCs, monitoring and performing operations on SDDCs and managing the lifecycle of management software therein have proven to be challenging. Some of such operations, referred to herein as “mutation operations,” change the states of SDDCs. Examples of mutation operations include upgrading software running on the hosts of SDDCs and migrating data between data stores of SDDCs. To preserve the security of SDDCs, it is important to ensure that such operations are only performed by administrators and/or software services that are trusted. It is also important to maintain records of such activity, e.g., identifying which administrators initiated the operations.

However, preserving the security of SDDCs has proven challenging for various types of operations. For example, cryptographic tokens may be distributed for authentication and authorization with management software of the SDDCs when issuing commands thereto. Those tokens are valid for predetermined periods of time such as thirty minutes, each such period of time also referred to as a “time-to-live (TTL) period” or simply a “TTL.” However, one type of operation, referred to herein as a “long-running operation,” lasts longer than the TTL of such a token. For example, upgrading software running in hundreds of hosts may take days.

Long-running operations may even include several commands to issue over a long time period. Accordingly, such a token may be valid when a first command is issued but invalid by the time a second command is issued. Another type of operation, referred to herein as a “scheduled operation,” is an operation with a specified time to execute, e.g., a time of the day and/or a day of the week. Indeed, an issued token may become invalid long before it is time to issue a scheduled operation. Given the increasing complexities of SDDC deployments such as with hybrid deployments, a simple and scalable method is needed for securely issuing operations to SDDCs, including long-running and scheduled operations.

### SUMMARY

One or more embodiments provide a method of issuing one or more commands for a management appliance of an SDDC to perform an operation. The method includes the steps of: retrieving the operation to be performed by the management appliance; transmitting a request to the management appliance for a first token, wherein the first token is associated with permissions for issuing commands to the management appliance, and wherein the request for the first token includes a second token that is associated with the initiator of the operation and that has a longer time-to-live period than the first token has; and upon receiving the first token from the management appliance, transmit the first token and a command to the management appliance, wherein the command is for the management appliance to execute at least one task of the operation.

Further embodiments include a non-transitory computer-readable storage medium comprising instructions that cause a computer system to carry out the above method, as well as an agent platform appliance configured to carry out the above method.

### BRIEF DESCRIPTION OF THE DRAWINGS

FIG. 1 is a block diagram of customer environments of different organizations that are managed through a multi-tenant cloud platform implemented in a public cloud.

FIG. 2 is a block diagram of the public cloud and an SDDC of one of the customer environments, according to embodiments.

FIG. 3 is a diagram illustrating a sequence of steps performed at the public cloud and the customer environment to securely transmit one or more commands to the SDDC.

FIG. 4 is a flow diagram of a method performed by an agent platform appliance of the customer environment to securely transmit one or more commands to the SDDC.

### DETAILED DESCRIPTION

Techniques are described for securely issuing operations to SDDCs, including long-running and scheduled operations. According to embodiments, a cloud platform delivers various services to the SDDCs through agents that are running in an appliance. The services of the cloud platform are referred to herein as “cloud services,” and the appliance in which the agents are running is referred to as an “agent platform (AP) appliance.” The cloud platform is provisioned in a public cloud, and the AP appliance is deployed in a customer environment along with management appliances of the SDDCs.

Each of the cloud services has a corresponding agent on the AP appliance that the cloud service communicates with. Furthermore, the AP appliance and management appliances are connected to each other over a private network of the customer environment. Accordingly, the cloud services and management appliances are able to communicate through the agents of the AP appliance. Through such communication, the cloud services issue operations to be performed by the management appliances.

According to techniques, the cloud platform acquires a token associated with a particular administrator of the customer environment, referred to herein as a “persistable token.” In the case of scheduled operations, the cloud platform then waits until a specified time before transmitting the operation to the AP appliance. In the case of other operations, including long-running operations, the cloud platform transmits the operation to the AP appliance upon receiving the persistable token. The time-to-live (TTL) period of the persistable token is sufficiently long to still be valid when it is time for a scheduled operation and at least as long as it takes for the management appliance to perform a long-running operation.

Upon receiving the operation from the cloud platform, the AP appliance acquires the persistable token from the cloud platform. The AP appliance then transmits the persistable token to a management appliance of an SDDC. Upon verifying the persistable token, the management appliance transmits a short-lived access token to the AP appliance such as a Security Assertions Markup Language (SAML) token. The short-lived access token is associated with permissions for issuing commands to the management appliance but has a shorter TTL than the persistable token has. The AP appliance then transmits a command to the management appliance to perform at least one task of the operation.

For some operations, the AP appliance only transmits a single command to the management appliance, the single command requesting performance of an entire operation requested by an administrator. For other operations, the AP appliance breaks the operations into constituent tasks. In such cases, each time a short-lived access token expires, the AP appliance again transmits the persistable token to the management appliance to acquire a new short-lived access token (i.e., a new instance of the short-lived access token). For each task, the AP appliance transmits a command to the management appliance and a valid short-lived access token (that has not yet expired).

Because the persistable token lasts sufficiently long, the persistable token may be used by the AP appliance for completing all operations, including both scheduled and long-running operations. Additionally, because the persistable token is associated with a particular administrator, any actions performed using the persistable token may be assumed to be performed on behalf of that administrator. Accordingly, it is possible to record, in an auditing log, information indicating which administrator initiated which operations (and constituent tasks). These and further aspects of the invention are discussed below with respect to the drawings.

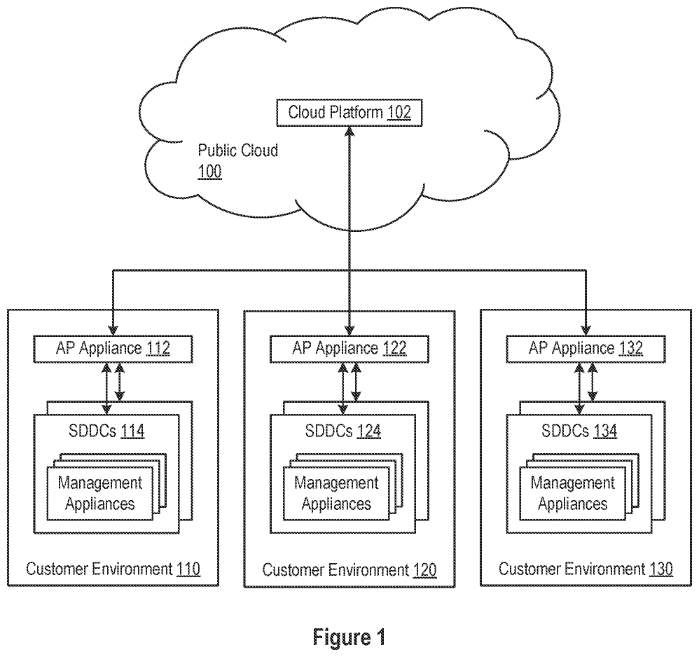

FIG. 1 is a block diagram of customer environments 110, 120, and 130 of different organizations (customers). The customer environments are managed through a multi-tenant cloud platform 102 implemented in a public cloud 100. A plurality of SDDCs is illustrated in each of the customer environments, including SDDCs 114 in customer environment 110, SDDCs 124 in customer environment 120, and SDDCs 134 in customer environment 130. As used herein, a “customer environment” means one or more on-premise IT environments managed by an organization, a private cloud managed by the organization, a public cloud managed for the organization by another organization, or any combination of these.

In each customer environment, the SDDCs are managed by respective management appliances. The management appliances of each of the customer environments include a VM management appliance (e.g., a VMware vCenter Server® appliance, available from VMware, Inc.) for overall management of VI. The management appliances of each of the customer environments further include a network management appliance (e.g., a VMware NSX® appliance, available from VMware, Inc.) for management of SDNs.

In each of the customer environments, an AP appliance communicates with the management appliances, the AP appliances including an AP appliance 112 in customer environment 110, an AP appliance 122 in customer environment 120, and an AP appliance 132 in customer environment 130. Agents (not shown in FIG. 1) are installed on each of the AP appliances, and the agents communicate with cloud platform 102 to deliver cloud services to respective customer environments. In some embodiments, each of the AP appliances and each of the management appliances are a VM instantiated on a host. In other embodiments, any of the AP appliances and the management appliances are implemented as hosts.

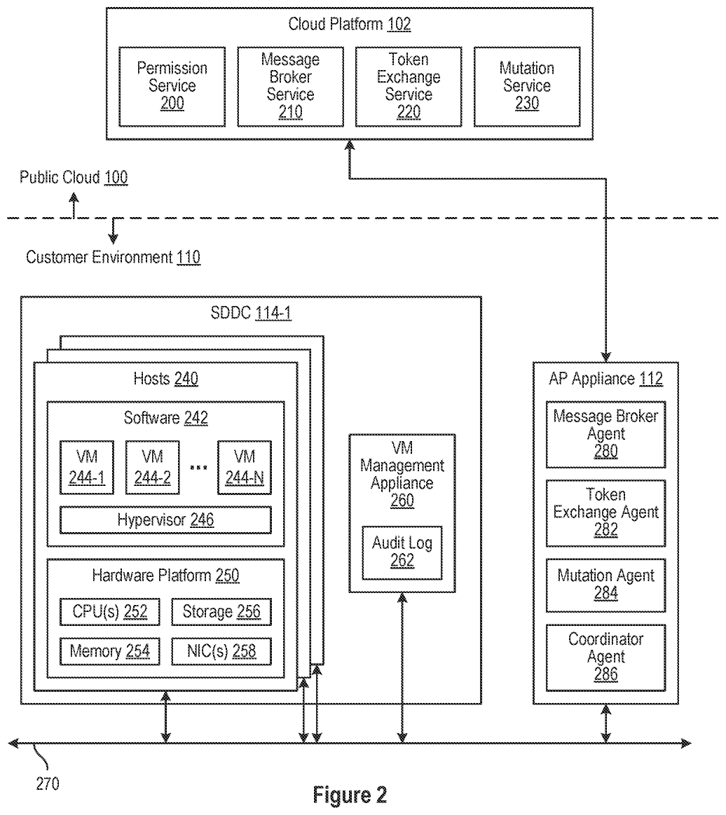

FIG. 2 is a block diagram of public cloud 100 and customer environment 110, according to embodiments. Customer environment 110 includes an SDDC 114-1, which includes a plurality of hosts 240 and a VM management appliance 260. Each of hosts 240 is constructed on a hardware platform 250 such as an x86 architecture platform. Hardware platform 250 includes conventional components of a computing device, such as one or more central processing units (CPUs) 252, memory 254 such as random-access memory (RAM), storage 256 such as one or more magnetic drives or solid-state drives (SSDs) and/or a host bus adapter for connecting to a storage area network (not shown), and one or more network interface cards (NICs) 258. CPU(s) 252 are configured to execute instructions such as executable instructions that perform one or more operations described herein, which may be stored in memory 254. NIC(s) 258 enable hosts 240 to communicate with each other and with other devices over a network 270.

Network 270 is distinguishable from a public network such as the Internet through which cloud platform 102 communicates with devices of customer environment 110. Network 270 is a private network, e.g., a local area network (LAN) or a sub-net, and is partitioned from the public network through a firewall. Hardware platform 250 of each of hosts 240 supports software 242. Software 242 includes a hypervisor 246, which is a virtualization software layer. Hypervisor 246 supports a VM execution space within which VMs 244 are concurrently instantiated and executed. One example of hypervisor 246 is a VMware ESX® hypervisor, available from VMware, Inc.

VM management appliance 260 logically groups hosts 240 into one or more clusters to perform cluster-level tasks such as provisioning and managing VMs 244 and migrating VMs 244 from one of hosts 240 to another. VM management appliance 260 communicates with hosts 240 via a management logical network (not shown) provisioned from network 270. In embodiments described herein, VM management appliance 260 is one of VMs 244 or one of hosts 240. However, in other embodiments, VM management appliance 260 is implemented via virtual computing instances besides VMs such as containers, Docker® containers, data compute nodes, and isolated user space instances. VM management appliance 260 includes an audit log 262, which is a record of information about commands performed by VM management appliance 260, e.g., identifying initiators of such commands.

VM management appliance 260 issues tokens that are each associated by customer environment 110 and public cloud 100 with one administrator of customer environment 110. Such tokens, referred to herein as “persistable tokens,” have long enough TTLs to remain valid as VM management appliance 260 performs scheduled and long-running operations. VM management appliance 260 also issues role-based, short-lived access tokens such as SAML tokens. Each short-lived access token allows a party possessing the token to access VM management appliance 260 to perform operations that are associated by VM management appliance 260 with the issued token.

Public cloud 100 is operated by a cloud computing service provider from a plurality of hosts (not shown). Cloud platform 102 includes a plurality of cloud services, including a permission service 200, a message broker service 210, a token exchange service 220, and a plurality of mutation services such as a mutation service 230. Permission service 200 enables authentication with other cloud services. To enable such authentication, permission service 200 issues access tokens such as JavaScript Object Notation (JSON) web tokens (JWTs).

Additionally, permission service 200 issues access tokens that are associated by customer environment 110 and public cloud 100 with permissions for acquiring persistable tokens. Each of such tokens is also associated by customer environment 110 and public cloud 100 with a single administrator of customer environment 110. Such tokens are referred to herein as “scoped tokens.” It should be noted that although permission service 200 is illustrated as being within cloud platform 102, permission service 200 may run on a VM or host that is outside of cloud platform 102 but accessible thereto.

Message broker service 210 is used by other cloud services for communicating with AP appliance 112, as discussed further below. Token exchange service 220 performs various functions for enabling mutation services to securely issue operations to management appliances. For example, token exchange service 220 acquires a persistable token from VM management appliance 260 to be used at AP appliance 112 for acquiring short-lived access tokens, as discussed further below. Mutation service 230 issues operations to management appliances such as scheduled operations and long-running operations. For example, one such operation may be for VM management appliance 260 to upgrade hypervisor 246 for each of hosts 240, which may take several days. Mutation service 230 may be, e.g., an upgrade service or a monitoring service for SDDCs including SDDC 114-1.

AP appliance 112 includes a message broker agent 280, a token exchange agent 282, a mutation agent 284, and a coordinator agent 286. Message broker agent 280 communicates with message broker service 210 to establish communication between cloud platform 102 and AP appliance 112. Agents of AP appliance 112 transmit messages to message broker agent 280, and cloud services of cloud platform 102 transmit messages to message broker service 210. Message broker service 210 and message broker agent 280 periodically exchange respective messages.

Upon a message exchange, message broker service 210 distributes messages from AP appliance 112 to other cloud services. Similarly, message broker agent 280 distributes messages from cloud platform 102 to other agents. Token exchange agent 282 communicates with token exchange service 220 to enable the various functions of token exchange service 220. Mutation agent 284 communicates with mutation service 230 to enable mutation service 230 to issue commands to VM management appliance 260 and to enable VM management appliance 260 to report results of such commands to mutation service 230.

Coordinator agent 286 installs the other agents and manages the lifecycles thereof. In embodiments described herein, AP appliance 112 is one of VMs 244 or one of hosts 240. However, in other embodiments, AP appliance 112 is implemented via other types of virtual computing instances besides VMs such as containers, Docker® containers, data compute nodes, and isolated user space instances.

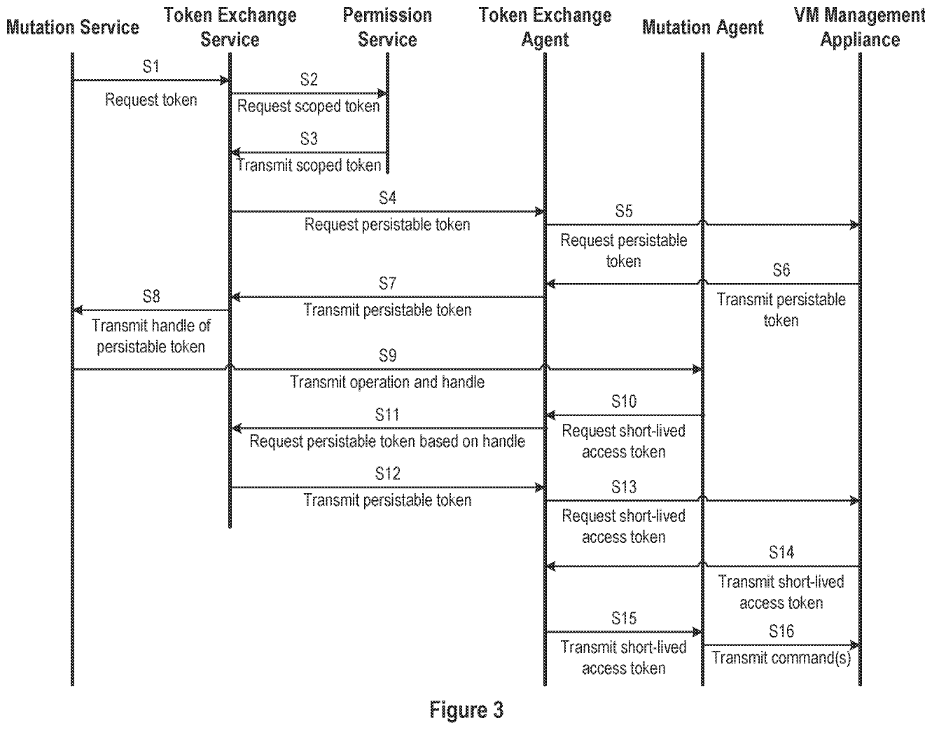

FIG. 3 is a diagram illustrating a sequence of steps performed at public cloud 100 and customer environment 110 to securely transmit one or more commands to an SDDC such as SDDC 114-1. At step 1, upon receiving an operation from an administrator of customer environment 110, mutation service 230 requests a token from token exchange service 220. At step 2, token exchange service 220 transmits a request to permission service 200 for a scoped token associated with the administrator who initiated the operation. Token exchange service 220 also transmits a JWT token associated with the organization (customer) of customer environment 110 to permission service 200.

At step 3, upon verifying the JWT token, permission service 200 transmits a scoped token to token exchange service 220. The scoped token is associated with the administrator who initiated the operation, i.e., associated with permissions for acquiring a persistable token for the administrator. At step 4, token exchange service 220 transmits a request to token exchange agent 282 for a persistable token. Token exchange service 220 also transmits the scoped token to token exchange agent 282. As mentioned above, token exchange service 220 transmits the request and scoped token via message broker service 210 and message broker agent 280.

At step 5, token exchange agent 282 transmits a request to VM management appliance 260 for the persistable token. Token exchange agent 282 also transmits the scoped token to VM management appliance 260. At step 6, upon verifying the scoped token, VM management appliance 260 transmits a corresponding persistable token to token exchange agent 282. Like the scoped token, the persistable token is associated with the administrator who initiated the operation.

At step 7, token exchange agent 282 transmits the persistable token to token exchange service 220 via message broker agent 280 and message broker service 210. At step 8, token exchange service 220 transmits a handle of the persistable token to mutation service 230. The handle is a sequence of characters associated by token exchange service 220 with the persistable token, such as a pointer to the persistable token. At step 9, mutation service 230 transmits the operation to mutation agent 284 via message broker service 210 and message broker agent 280. Mutation service 230 also transmits the handle to mutation agent 284. If the operation is a scheduled operation, mutation service 230 waits until the time specified by the administrator before transmitting the operation and handle.

At step 10, mutation agent 284 transmits a request to token exchange agent 282 for a short-lived access token such as a SAML token for issuing one or more commands to VM management appliance 260. Mutation agent 284 also transmits the handle to token exchange agent 282. At step 11, token exchange agent 282 transmits a request to token exchange service 220 for the persistable token via message broker agent 280 and message broker service 210. Token exchange agent 282 also transmits the handle to token exchange service 220.

At step 12, upon retrieving the persistable token based on the handle, token exchange service 220 transmits the persistable token to token exchange agent 282 via message broker service 210 and message broker agent 280. At step 13, token exchange agent 282 transmits a request to VM management appliance 260 for a short-lived access token. Token exchange agent 282 also transmits the persistable token to VM management appliance 260. At step 14, upon verifying the persistable token, VM management appliance 260 transmits the short-lived access token to token exchange agent 282.

At step 15, token exchange agent 282 transmits the short-lived access token to mutation agent 284. At step 16, mutation agent 284 transmits one or more commands to VM management appliance 260. Mutation agent 284 also transmits the short-lived access token to VM management appliance 260. Upon verifying (i.e., authenticating and authorizing) the short-lived access token, VM management appliance 260 performs the one or more commands and persists records of the one or more commands in audit log 262. For some operations, mutation agent 284 breaks an operation into a plurality of tasks, and mutation agent 284 transmits a command to VM management appliance 260 for each of the tasks, as discussed further below.

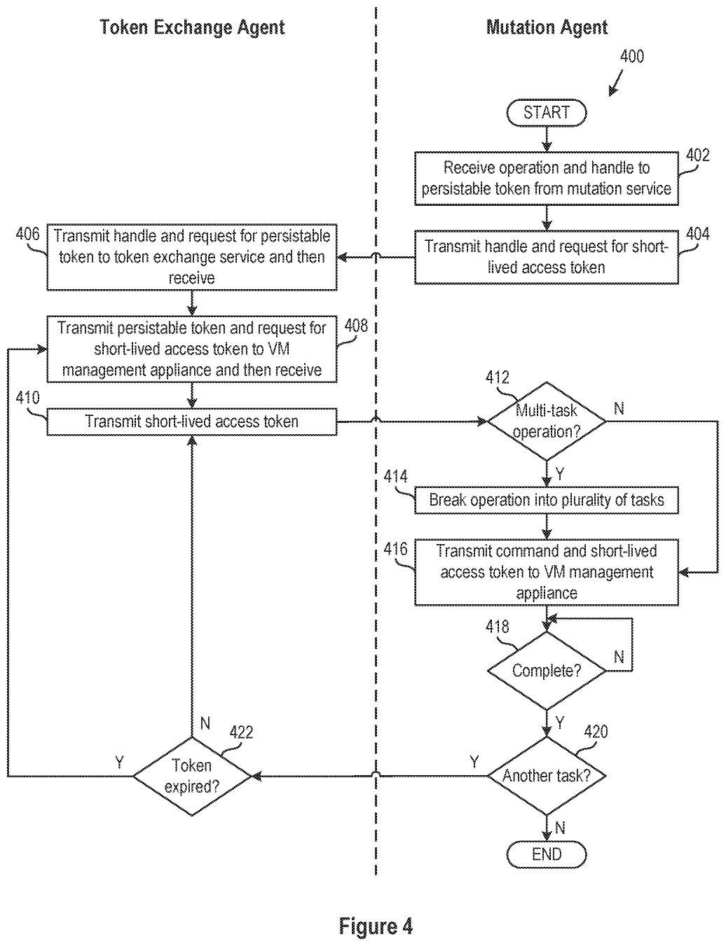

FIG. 4 is a flow diagram of a method 400 performed by AP appliance 112 to securely transmit one or more commands to an SDDC such as SDDC 114-1. Method 400 is performed after token exchange agent 282 acquires a persistent token from VM management appliance 260 and transmits the persistent token to token exchange service 220, as discussed above in conjunction with steps 1-7 of FIG. 3. At step 402, mutation agent 284 receives an operation and a handle to a persistable token from mutation service 230. The operation may be, e.g., to upgrade hypervisor 246 for each of hosts 240. If the operation is a scheduled operation, mutation service 230 transmits the operation and the handle at the specified time for VM management appliance 260 to perform the operation.

At step 404, mutation agent 284 transmits the handle and a request for a short-lived access token such as a SAML token to token exchange agent 282. At step 406, token exchange agent 282 transmits the handle and a request for the associated persistable token to token exchange service 220 via message broker agent 280 and message broker service 210. Token exchange agent 282 then receives the associated persistable token from token exchange service 220. The persistable token is associated with the administrator who initiated the operation received at step 402.

At step 408, token exchange agent 282 transmits the persistable token and a request for a short-lived access token to VM management appliance 260. Token exchange agent 282 then receives a short-lived access token from VM management appliance 260. The short-lived access token is associated with permissions for issuing commands to VM management appliance 260. At step 410, token exchange agent 282 transmits the short-lived access token to mutation agent 284.

At step 412, mutation agent 284 determines whether the operation received at step 402 should be split into a plurality of tasks, i.e., if the operation is a multi-task operation. For example, if the operation is to upgrade hypervisor 246 of each of hosts 240, a first task may be to check if hardware platform 250 of each of hosts 240 supports a new software version for hypervisor 246. A second task may be to upgrade hypervisor 246 for a first group of hosts 240. A third task may be to upgrade hypervisor 246 for a second group of hosts 240.

If the operation is a multi-task operation, method 400 moves to step 414. At step 414, mutation agent 284 breaks the operation in a plurality of tasks (steps). Returning to step 412, if the operation is not a multi-task operation, method 400 moves directly to step 416. At step 416, mutation agent 284 transmits a command and the short-lived access token to VM management appliance 260. If the operation is a multi-task operation, the command is to perform the next task of the operation. If the operation is not a multi-task operation, the command is to perform the entire operation.

At step 418, if VM management appliance 260 has not yet completed the operation (or the task in the case of a multi-task operation), step 418 repeats. Eventually, when VM management appliance 260 has completed the operation (or task), VM management appliance 260 transmits a response to mutation agent 284 indicating the completion, and method 400 moves to step 420. The response also includes results of the operation (or task). VM management appliance 260 also persists information in audit log 262 identifying the administrator who initiated the operation received at step 402 as having acquired the short-lived access token and as having issued the command. For example, VM management appliance 260 may store the short-lived access token in association with the command, the short-lived access token being associated with the persistable token (and by extension, with the administrator). At step 420, if there is another task to complete (in the case of a multi-task operation), method 400 moves to step 422.

At step 422, token exchange agent 282 determines if the short-lived access token has expired. If the short-lived access token has expired, method 400 returns to step 408, and token exchange agent 282 transmits the persistable token and a request for a new short-lived access token to VM management appliance 260 and receives the new short-lived access token (i.e., a new instance of the short-lived access token) to be used for issuing the next task of the operation. As mentioned earlier, the TTL of the persistable token is long enough to complete a long-running operation, e.g., several days. A short-lived access token has a shorter TTL such as thirty minutes. Accordingly, the persistable token may be used several times to request short-lived access tokens as VM management appliance 260 performs tasks.

Returning to step 422, if the current short-lived access token has not yet expired, method 400 instead returns to step 410, and token exchange agent 282 transmits the current short-lived access token to mutation agent 284. Returning to step 420, if there are no tasks left for VM management appliance 260 to complete, method 400 ends. For a multi-task operation, steps 408-420 may each be performed several times. For other operations, steps 408-420 are each only performed once.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are magnetic drives, SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of issuing one or more commands for a management appliance of a software-defined data center (SDDC) to perform an operation, the method comprising:
retrieving the operation to be performed by the management appliance;
transmitting a request to the management appliance for a first token, wherein the first token is associated with permissions for issuing commands to the management appliance, and wherein the request for the first token includes a second token that is associated with the initiator of the operation and that has a longer time-to-live period than the first token has; and
upon receiving the first token from the management appliance, transmitting the first token and a command to the management appliance, wherein the command is for the management appliance to execute at least one task of the operation.

2. The method of claim 1, wherein the steps of retrieving the operation, transmitting the request for the first token, and transmitting the first token and the command, are carried out in an agent platform appliance that is connected to a management network of the SDDC.

3. The method of claim 1, further comprising:
upon receiving a third token from a token exchange cloud service of a cloud platform, transmitting the third token to the management appliance along with a request for the second token and then receiving the second token from the management appliance, wherein the third token is associated with permissions for acquiring the second token.

4. The method of claim 1, further comprising:
transmitting to a token exchange cloud service of a cloud platform, a request for the second token, and then receiving the second token from the token exchange cloud service.

5. The method of claim 1, wherein in an audit log, information is persisted that identifies the first token as being used for issuing the command to the management appliance.

6. The method of claim 1, further comprising:
acquiring the second token from the management appliance, wherein the operation is specified by the initiator of the operation to be performed at a scheduled time, and wherein the amount of time that elapses between acquiring the second token from the management appliance and the scheduled time is greater than the time-to-live period of the first token.

7. The method of claim 1, further comprising:
in response to the time-to-live period of the first token expiring, transmitting a request to the management appliance for another instance of the first token, wherein the request for the other instance of the first token includes the second token; and
upon receiving the other instance of the first token from the management appliance, transmitting the other instance of the first token and another command to the management appliance, wherein the other command is for the management appliance to execute another at least one task of the operation.

8. A non-transitory computer-readable medium comprising instructions that are executable in a computer system, wherein the instructions when executed cause the computer system to carry out a method of issuing one or more commands for a management appliance of a software-defined data center (SDDC) to perform an operation, the method comprising:
retrieving the operation to be performed by the management appliance;
transmitting a request to the management appliance for a first token, wherein the first token is associated with permissions for issuing commands to the management appliance, and wherein the request for the first token includes a second token that is associated with the initiator of the operation and that has a longer time-to-live period than the first token has; and
upon receiving the first token from the management appliance, transmitting the first token and a command to the management appliance, wherein the command is for the management appliance to execute at least one task of the operation.

9. The non-transitory computer-readable medium of claim 8, wherein the steps of retrieving the operation, transmitting the request for the first token, and transmitting the first token and the command, are carried out in an agent platform appliance that is connected to a management network of the SDDC.

10. The non-transitory computer-readable medium of claim 8, wherein the method further comprises:
upon receiving a third token from a token exchange cloud service of a cloud platform, transmitting the third token to the management appliance along with a request for the second token and then receiving the second token from the management appliance, wherein the third token is associated with permissions for acquiring the second token.

11. The non-transitory computer-readable medium of claim 8, wherein the method further comprises:
transmitting to a token exchange cloud service of a cloud platform, a request for the second token, and then receiving the second token from the token exchange cloud service.

12. The non-transitory computer-readable medium of claim 8, wherein in an audit log, information is persisted that identifies the first token as being used for issuing the command to the management appliance.

13. The non-transitory computer-readable medium of claim 8, wherein the method further comprises:
acquiring the second token from the management appliance, wherein the operation is specified by the initiator of the operation to be performed at a scheduled time, and wherein the amount of time that elapses between acquiring the second token from the management appliance and the scheduled time is greater than the time-to-live period of the first token.

14. The non-transitory computer-readable medium of claim 8, wherein the method further comprises:
in response to the time-to-live period of the first token expiring, transmitting a request to the management appliance for another instance of the first token, wherein the request for the other instance of the first token includes the second token; and
upon receiving the other instance of the first token from the management appliance, transmitting the other instance of the first token and another command to the management appliance, wherein the other command is for the management appliance to execute another at least one task of the operation.

15. An agent platform appliance configured to execute on a processor of a hardware platform to perform a method of issuing one or more commands for a management appliance of a software-defined data center (SDDC) to perform an operation, wherein the method comprises:
retrieving the operation to be performed by the management appliance;
transmitting a request to the management appliance for a first token, wherein the first token is associated with permissions for issuing commands to the management appliance, and wherein the request for the first token includes a second token that is associated with the initiator of the operation and that has a longer time-to-live period than the first token has; and
upon receiving the first token from the management appliance, transmitting the first token and a command to the management appliance, wherein the command is for the management appliance to execute at least one task of the operation.

16. The agent platform appliance of claim 15, wherein the method further comprises:
upon receiving a third token from a token exchange cloud service of a cloud platform, transmitting the third token to the management appliance along with a request for the second token and then receiving the second token from the management appliance, wherein the third token is associated with permissions for acquiring the second token.

17. The agent platform appliance of claim 15, wherein the method further comprises:
transmitting to a token exchange cloud service of a cloud platform, a request for the second token, and then receiving the second token from the token exchange cloud service.

18. The agent platform appliance of claim 15, wherein in an audit log, information is persisted that identifies the first token as being used for issuing the command to the management appliance.

19. The agent platform appliance of claim 15, wherein the method further comprises:
acquiring the second token from the management appliance, wherein the operation is specified by the initiator of the operation to be performed at a scheduled time, and wherein the amount of time that elapses between acquiring the second token from the management appliance and the scheduled time is greater than the time-to-live period of the first token.

20. The agent platform appliance of claim 15, wherein the method further comprises:
in response to the time-to-live period of the first token expiring, transmitting a request to the management appliance for another instance of the first token, wherein the request for the other instance of the first token includes the second token; and
upon receiving the other instance of the first token from the management appliance, transmitting the other instance of the first token and another command to the management appliance, wherein the other command is for the management appliance to execute another at least one task of the operation.
